(19) United States
(12) Patent Application Publication
(10) Pub. No.: US 2006/0106136 A1
(43) Pub. Date: May 18, 2006

(54) Weatherable, mechanically stable polypropylene based date palm reinforced composites

(76) Inventor: Basel F. Abu-Sharkh, Dhahran (SA)

Correspondence Address: LITMAN LAW OFFICES, LTD, PO BOX 15035, CRYSTAL CITY STATION, ARLINGTON, VA, 22215, US

(21) Appl. No.: 10/989,662

(22) Filed: Nov. 17, 2004

(51) Int. Cl. C08L 5/00

(52) U.S. Cl. 524/27

(57) ABSTRACT

The weatherable, mechanically stable polypropylene based date palm reinforced composites comprise: (a) at least one cellulosic material derived from date palm leaves and stems present in an amount within the range of from about 20% to about 50% by weight of the composite, (b) at least one polypropylene material present in an amount in the range of from about 50% to about 80% by weight of the composite, and (c) at least one UV stabilizing material present in an amount in the range of from about 0.1% to about 0.5% by weight of the composite. The present invention also includes a method of making the above-describe composites. The composites of the present invention have a mechanical strength that is comparable or exceeds that of polypropylene material alone and is more stable under weathering conditions of Saudi Arabia than polypropylene alone.

### BACKGROUND OF THE INVENTION

1. Field of the Invention

The present invention relates to reinforced composites. More particularly, the present invention relates to polypropylene/cellulose reinforced composites and their method of making.

2. Description of the Related Art

Polyolefin materials such as polyethylene and polypropylene have been available in a variety of grades and forms. The use of polypropylene in outdoor applications has been limited by its structural capacity and its inability to resist damaging weather conditions such as heat, light and cold. Recently, polypropylene has been used in a variety of applications in which the polypropylene is combined with a reinforcing material or composition. For example, Shinomura, U.S. Pat. No. 3,888,810, describes a thermoplastic composite comprising a thermoplastic resin, fibrous materials, and preferably synthetic or natural rubbers. Jones, U.S. Pat. No. 3,917,901, describes a conductor having an insulative layer comprising a polyolefin-wood composite. Nakano et al., U.S. Pat. No. 3,962,157, describes a polypropylene composition modified with a porous filler and a free radical agent that promotes reaction between the filler and the polymer. Layer, U.S. Pat. No. 5,516,472, describes an apparatus and method for making a composite from combining organic fibrous material, including palm fiber (See Column 6, line 39) which forms, internally, pellet-like strands that are then recombined to form extruded parts. Korney, WIPO WO 99/111444 describes continuous in-line compounding and extrusion system not requiring pre-dried cellulosic/polymer for extrusion and includes the use of palm fiber (See Page 6, line 21) as a cellulosic material useful in the system.

Related art also includes a substantial number of methods to compatibilize a combination of a polyolefin with a cellulose filler using such materials as plasticizers, monomeric silicone-containing compounds, grafted silyl moieties on either the polymer or the filler, polyolefin lubricants, blends of varied types of polymers in combination with the primary polyolefin, synthetic elastomers and rubbers, methylol phenolic modified polyolefins, blends of ethylene polymers and polypropylene polymers, in situ polymerization of monomers onto a fiber used in the making of a composite, specialized fibers including polytetrafluoroethyline fibers, expanded or otherwise specially modified polyolefins, glyoxal and other types of thermally reactive crosslinking agents, modified cellulosic fibers including the use of metals, crosslinking agents, compatibilizing agents, etc., and the resulting products.

Wold, U.S. Pat. No. 5,435,954, describes a molding method for forming a composite into a useful article. Kourgli, U.S. Pat. No. 5,542,780, describes a polypropylene composite having an elastic modulus of about 500,000 or less. Coran et al., U.S. Pat. No. 4,323,625, describes a polypropylene composite having 20 wt. % of a hardwood pulp and a modulus less than 200,000. Nishibori, U.S. Pat. No. 5,725,939, describes a wood meal polypropylene composite with 50% polymer and a modulus less than 400,000. Beshay, U.S. Pat. No. 4,717,742, describes an aspen pulp-polypropylene composite having 40 wt. % pulp and a tensile modulus less than 100,000. Beshay, U.S. Pat. No. 4,820,749, describes an aspen pulp polypropylene composite having about 40 wt. % pulp and a modulus of less than 100,000. Dehennau et al., U.S. Pat. No. 5,164,432 and Bortoluzzi et al., describe sawdust-containing composites with less than 50 wt. % fiber and a modulus less than 800,000. Malucelli et al., EP Application No. 540026, describes a wood flour polypropylene composite having 50 wt. % polymer and a modulus less than 700,000.

Clemons, C. M. et al., in “Microstructure and Dynamic Fracture Toughness of Polypropylene Reinforced with Cellulose Fiber”, ANTEC '98, pp. 1432-1436(1998), describes the micro-structure of injection-molded polypropylene reinforced with cellulose fiber obtained from dried pulp sheets of bleached chemical dissolving pulp.

Maier, C. et al., “Polypropylene, The Definitive User's Guide and Databook”, Plastics Design Library, page 53(1998), describes the use of wood flour as an organic filler used in polypropylene.

ABU-Sharkh, B. F., “Artificial and natural weathering of PP-palm fiber composites: Mechanical and Spectroscopic Characterization: 42^{nd} Microsymposium on Polymer Degradation and Recycling, Prague, Jul. 14-17, 2002 summarizes a presentation given by the present inventor.

A substantial need exists for an improved polypropylene-wood fiber composite material that can be extruded into a weatherable, stable material that can be used in engineering applications while exposed to exterior environments. In particular, a substantial need exists for the utilization of date palm fiber waste that becomes abundant in Saudi Arabia during the annual pruning season of palm trees. It would be desirable to provide a composition of and method of making a polypropylene-date palm fiber material extrudate and the resulting extruded article which is stable under the severe natural weathering conditions faced in Saudi Arabia and maintain mechanical strength comparable to that of polypropylene material which has not been weathered.

None of the above inventions and patents, taken either singly or in combination, is seen to describe the instant invention as claimed. Thus, weatherable, mechanically stable polypropylene-based, date palm-reinforced composites solving the aforementioned problems is desired.

### SUMMARY OF THE INVENTION

The weatherable, mechanically stable polypropylene based date palm reinforced composites of the present invention comprise: (a) at least one cellulosic material derived from date palm leaves and stems present in an amount within the range of from about 20% to about 50% by weight of the composite, (b) at least one polypropylene material present in an amount in the range of from about 50% to about 80% by weight of the composite, and (c) at least one UV stabilizing material present in an amount in the range of from about 0.1% to about 0.5% by weight of the composite. The present invention also includes a method of making the above-describe composites. The composites of the present invention have a mechanical strength that is comparable or exceeds that of polypropylene material alone and is more stable under weathering conditions of Saudi Arabia than polypropylene alone. The inventive composite material may utilize waste date palm cellulosic waste material that is produced in excess of 200 million kilograms annually.

It is an aspect of the invention to provide compositions for the purposes described which are inexpensive, dependable and fully effective for their intended purposes.

These and other aspects of the present invention will become readily apparent upon further review of the following specification and charts.

### BRIEF DESCRIPTION OF THE DRAWINGS

FIG. 1 is a chart showing percent strain at maximum load of naturally weathered polypropylene and naturally weathered composites of the present invention vs. exposure time.

FIG. 2 is a chart showing percent strain at maximum load of artificially weathered polypropylene and artificially weathered composites of the present invention vs. exposure time.

FIG. 3 is a chart showing stress at maximum load of naturally weathered polypropylene and naturally weathered composites of the present invention vs. exposure time.

FIG. 4 is a chart showing stress at maxim load of artificially weathered polypropylene and artificially weathered composites of the present invention vs. exposure time.

FIG. 5 is a chart showing the influence of varying the amount of compatibilizer (maleated polypropylene G3003 from Eastman Chemicals) on final mechanical properties of a composite containing about 30 weight percent date palm cellulose fibers.

### DETAILED DESCRIPTION OF THE PREFERRED EMBODIMENTS

The present invention is an improved polypropylene composite material employing date palm fiber as a component and a method of making the polypropylene composite material. The polypropylene-date palm fiber composite material when extruded into structural members provides improved mechanical properties to the structural member including improved tensile modulus and mechanical stability. It has been discovered that the weatherability of the composite material is substantially better than polypropylene material alone. More specifically, the inventive composite materials have been shown to maintain constant mechanical tensile strength over one year of exposure in natural weathering conditions of Saudi Arabia with temperatures that exceed 50° C. and humidity of up to 100% during the summer months.

In broad terms, the present invention includes a polypropylene-date palm fiber composite comprising: (a) at least one cellulosic material derived from date palm present in an amount in the range of from about 20% to about 50% by weight of the composite, (b) at least one polypropylene material present in an amount in the range of from about 50% to about 80% by weight of the composite, and (c) at least one polar modified polypropylene present in an amount in the range of from about 1% to about 6% by weight of the composite.

It is preferred that the date palm cellulosic material(s) is/are present in an amount in the range of about 30% to about 40% by weight of the inventive composite. It is also preferred that the date palm cellulosic material(s) be derived from the leaves, roots or stem of date palm and mixtures thereof. It is preferred that the total of polypropylene material(s) be present in an amount in the range of from about 60% to about 70% by weight. It is preferred that the total of polypropylene material(s) include polar modified polypropylene material(s) present in amount in the range of from about 1% to about 4% by weight of the composite.

Polypropylene resins useful in the present invention include any injection molding grade made by producers such as, for example, Dow grade T700 and British Petroleum-Amoco grade Fortilene® PP HB1952.

The present invention also includes an extruded article produced by extruding a composite of the present invention in its many embodiments as described herein.

The present invention also includes a method of extruding a composite in its many embodiments as describe herein, the method comprising extruding a composite as describe above.

The composite compound of the present invention consists essentially of rigid polypropylene blend compound, combined with relatively high loadings of cellulose reinforcement.

Among the polar modified materials which can be used in the making of the inventive composite compounds is maleated polypropylene. Examples of this maleated polypropylene include Epolene E-43 and Epolene G-3003 produced by Eastman Chemical Company. These are polypropylene polymers with molecular weight ranging from 15000 g/mol to 50,000 g/mol reacted with maleic anhydride to produce maleated polypropylene containing a maximum of 10 mol percent maleic anhydride. Other suppliers of maleated polypropylene are Uniroyal Chemical company under the name Polybond 3002 and DuPont chemical company under the name Fusabond MD 511D.

The polypropylene material may include a stabilizer in the range of about 0.1 parts per hundred (phr) to about 0.5 phr and lubricants in the range of about 4 phr to about 8 phr. Chemical stabilizers useful in the present invention include Irgastab FS 410 and Tinumin-783. The stabilizers serve to stabilize free radicals resulting from thermal (during processing) and UV (during exposure to solar radiation) attach and prevent them from further degrading the polymer.

It is preferred that the polypropylene material include a stabilizer in the range of about 0.2 phr to about 0.4 phr. and lubricants in the range of about 5 phr to about 7 phr.

Preferred stabilizers are high molecular tin stabilizers for environmental reasons; however, it is contemplated that lead and metal soaps, such as barium, cadmium, and zinc, should work similarly in practice of the present invention.

Common commercial lubricants known in the plastics processing industry, both internal and external, can be used in carrying out the extrusion process. Examples of lubricants which can be used in the practice of the present invention include calcium stearate, paraffin wax, and amide wax, for example, Honeywell AC-6 polyethylene wax or amide wax or Calford Wax 106 from Blachford Company. The wax serves to facilitate the molding process and provide lubrication during injection molding. This lubrication reduces energy consumption and minimizes fiber breakage during molding.

The composite material can be conveniently made by mixing the polypropylene resin with the stabilizer, lubricants, and any process aids in a single screw extruder or a conical twin screw extruder having counter-rotating screws, the mixing being carried out at a temperature of about 200° C. The mixed material may then be pelletized for further molding steps.

The date palm cellulose material is dried to between about 0.5% to 3% by weight in moisture content by weight, and preferably from about 1% to about 2% moisture content by weight.

### EXAMPLE 1

A polypropylene/date palm cellulose fiber composite was made as follows:

Polypropylene resin was combined with 0.5 phr stabilizer, 5 phr lubricants, and 4 phr polar modified polypropylene compatibilizer. The mixture was homogenized by hand. The polypropylene resin used was obtained from SABIC, Saudi Arabia, the commercial numbers being 571P, 575P, and 576P injection molding grade polymers.

The date palm (botanical name: phoenix) leaves and stems were cut into cubic pieces about 0.5 to 1.0 in. in length. Thereafter they were dried in the sun for a few days so that most of the moisture is removed. The pieces of branches were then granulated to a small size using a granulator. The fibers were then size separated by using a sieving machine. Two different size distributions of fibers (called large and small fibers) were obtained. The fiber size distributions were characterized using a digital vernier caliper. Only the larger fibers were used in preparing the composite materials. The average length of the large fibers was determined to be 4.77±1.75 mm. The fibers had an aspect ratio (length/diameter) of about 11. The fibers were then dried in a vacuum oven at 80° C. and 10⁻² bar to remove the moisture for 24 hours. The date palm fiber was dried to a moisture content of less than 2% by weight. The dried cellulose fiber (40% by weight) was mixed with the polypropylene mixture (60% by weight) in a ribbon blender for approximately 2 minutes.

The dry blend was then fed into the hopper of a single screw extruder (model S-650, Number G126 by Brabender, N.J.). The extruder melts and mixes the components to produce a homogeneous mixture at high pressure and produces a strand of composite material that is subsequently palletized (cut into small pieces) using a special rotating knife. The first two stages of the extruder were heated to about 220° C. The last two stages, which are located after the vent, were heated to about 200° C. The die temperature was also at about 200° C. The screw temperature was about 200° C. Vacuum was applied to the vent to further reduce the moisture in the extrudate.

The resulting pellets from the screw extruder were fed to an injection molding machine that melted the pellets and applied high pressure on the melt to feed it into molds of the final product shape. The pellets were molded into American Society of Mechanical Engineers standard mechanical testing specimen of size ASTM D-648-94B. The pellets can be molded into any final product shape, for example, a flat panel, a chair, or a disk. The temperature of the injection molding was within the range of 180 degrees C. to 230 degrees C. However, 200 degrees C. is the optimum processing temperature because it is sufficiently high to guarantee ease of processing and sufficiently low to prevent burning and sever degradation of the cellulose fibers.

Rectangular test bars were made measuring ¼ inch by ½ inch and having 40% Polypropylene material were made. The test bars were tested using ASTM K790. A modulus of 1800 Mega Pascal (MPa) with a peak stress of 30 MPa was obtained.

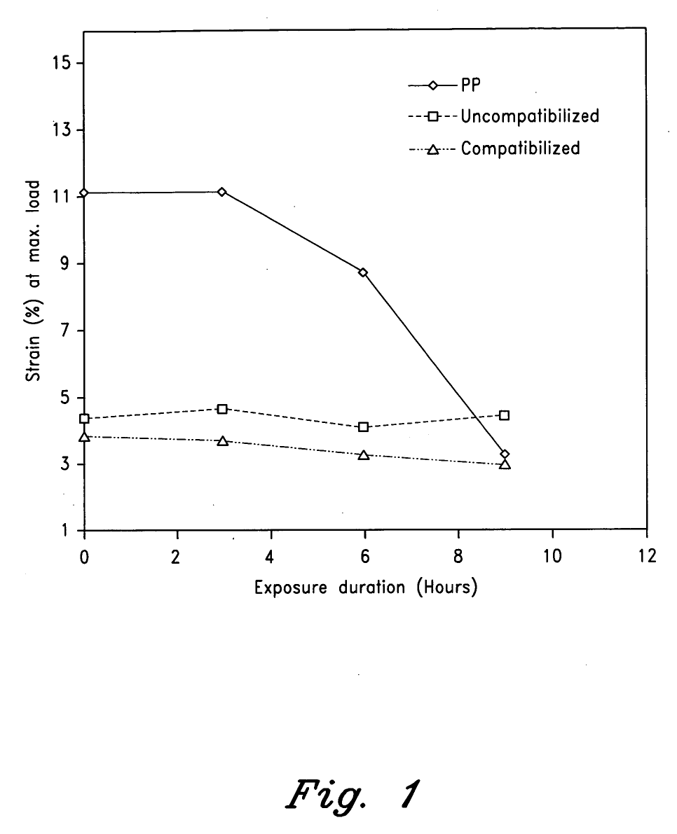

It can be concluded from the test results (See FIGS. 1-4) that the use of the polypropylene/date palm fiber composites allows for improved properties with reduced cost compared to polypropylene.

FIGS. 1 through 4 show the natural and artificial weathering comparison for polypropylene and polypropylene/date palm fiber composites (both compatibilized with polar modified polypropylene and uncompatibilized).

Referring to FIG. 1, there are shown charts of percent strain at maximum load of naturally weathered composites vs. exposure time. As can be seen, the percent strain at maximum load of polypropylene (PP) falls off rapidly from an initial value as compared to uncompatibilized and compatibilized Polypropylene/date palm fiber composites.

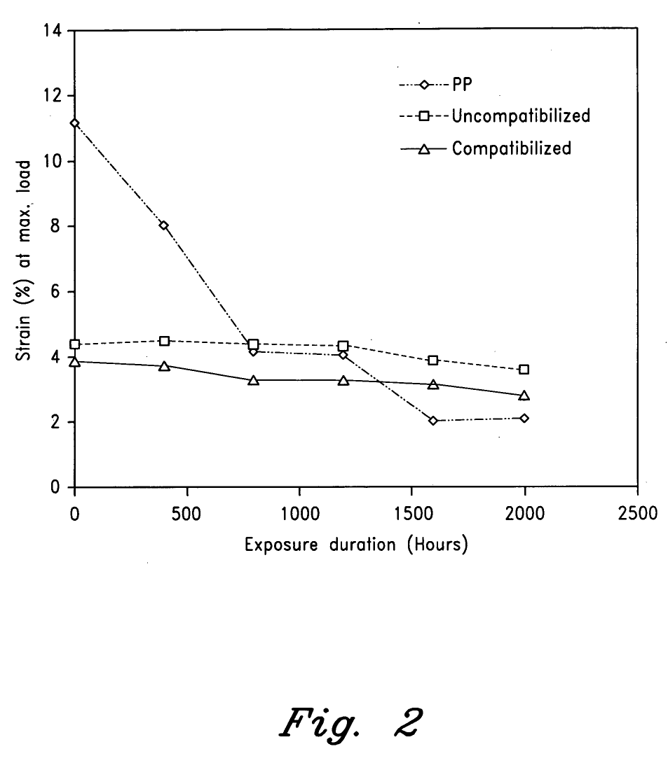

Referring to FIG. 2, there are shown charts of percent strain at maximum load of artificially weathered composites vs. exposure time. As can be seen, the percent strain at maximum load of polypropylene falls off to a point below that of the uncompatibilized and compatibilized Polypropylene/date palm fiber composites over a long duration exposure.

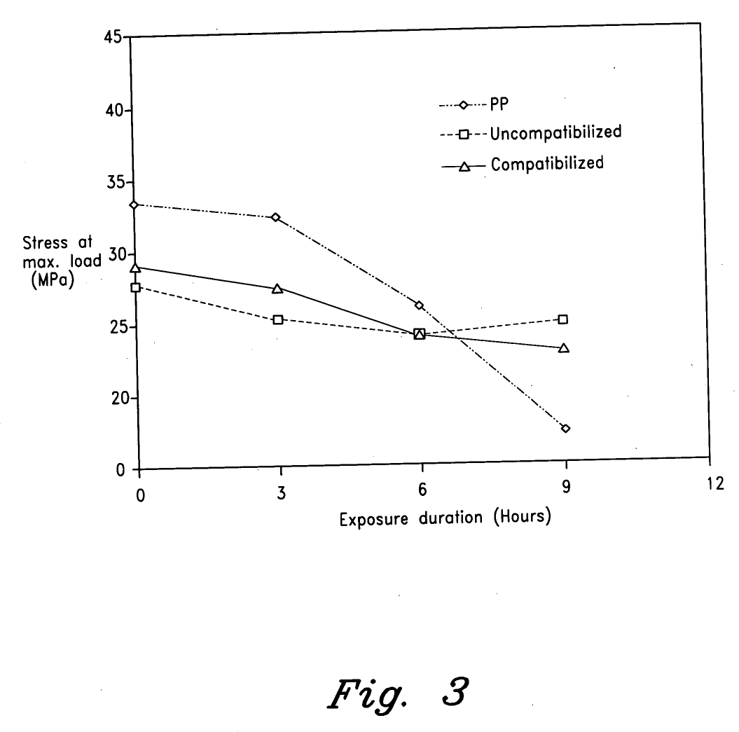

Referring to FIG. 3, there are shown charts of stress at maximum load of naturally weathered samples as a function of exposure time. As can be seen, the stress at maximum load of polypropylene falls off to a point below that of the uncompatibilized and compatibilized Polypropylene/date palm fiber composites.

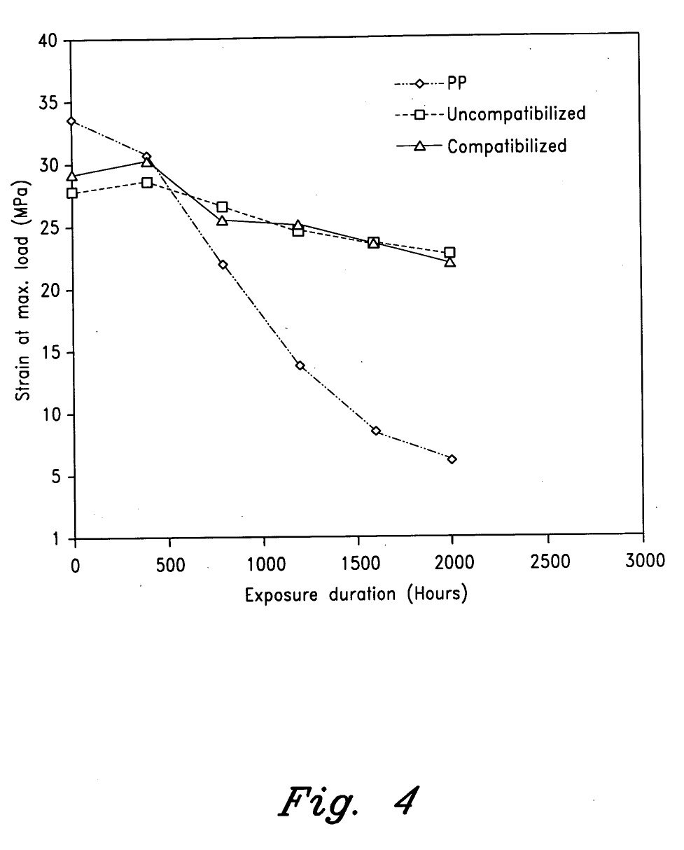

Referring to FIG. 4, there are shown charts of stress at maximum load of artificially weathered samples as a function of exposure time. As can be seen, the stress at maximum load of polypropylene falls off to a point considerably below that of the uncompatibilized and compatibilized Polypropylene/date palm fiber composites over a long duration exposure.

It is clear that the composites show much higher stability and resistance to degradation than the polypropylene.

### EXAMPLE 2

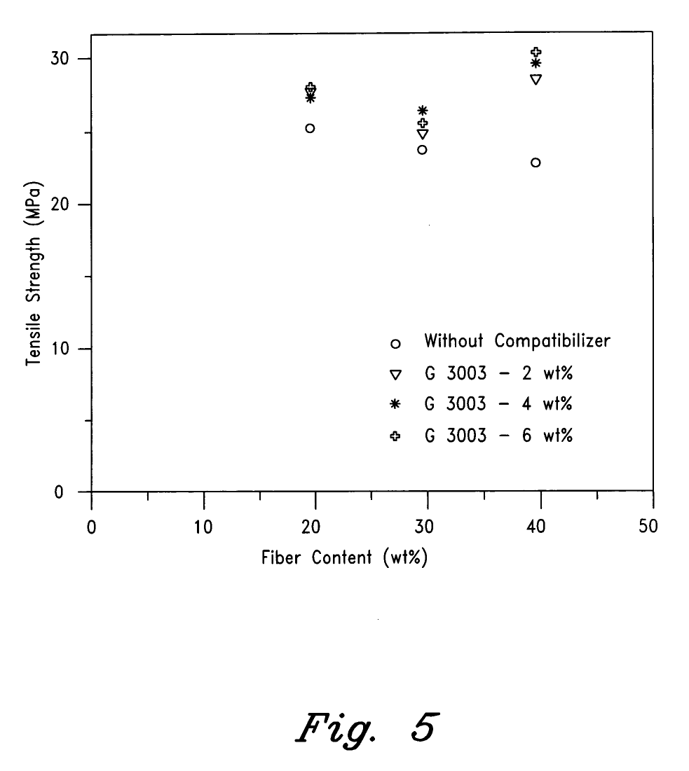

The influence of varying the amount of compatibilizer (maleated polypropylene G3003 from Eastman Chemicals) on final mechanical properties of a composite containing about 30 weight percent date palm cellulose fibers is illustrated in the diagram of FIG. 5. The composites were prepared according to the procedures of EXAMPLE 1, above, and contained 0.2 weight percent Irgastab FS410 stabilizer, 0.5 weight percent Tinuvin 783 stabilizer, and 2 weight percent polyethylene was. Both stabilizers were obtained from CIBA Chemicals Company. It is clear that increasing the polar polypropylene content increases the mechanical strength of the composite material from 22 to 30 MPa.

### EXAMPLE 3

Test specimens were made according to the procedure of EXAMPLE 1, above, employing by weight: 68 percent polypropylene, 29.19 percent date palm cellulose fibers, 2 percent polyethylene wax, 0.2 percent Irgastab FS 410 stabilizer, and 0.5 percent Tinumin-783 stabilizer. The specimen was prepared containing 0.0 percent, 2 percent, 4 percent, and 6 percent Compatibilizer (maleated polypropylene G3003 from Eastman Chemicals).

### EXAMPLE 4

Test specimens were made according to the procedure of EXAMPLE 1, above, employing by weight 63.19 percent polypropylene, 25.39 percent date palm cellulose fibers, 2 percent paraffin wax (plasticized), 0.2 percent Irgastab FS 410 stabilizer, and 0.4 percent Tinumin-783 stabilizer. The specimens were prepared containing 0.0 percent, 2 percent, 4 percent and 6 percent Compatibilizer (maleated polypropylene G3003 from Eastman Chemicals).

The reinforced composites of the present invention are useful as feed in injection molding and compression molding machines to make molded articles such as tensile test specimen, car seat components, garden chairs, flat sheets, and garden tables.

An example is feeding the reinforced composite pellets to an injection molding machine (Engel Electronics Model ES 80/25 ST at a pressure of 150 Bar and a temperature of 200° C.) to obtain tensile specimen of ASTM test standard No. D-638-94B.

It is to be understood that the present invention is not limited to the embodiments described above, but encompasses any and all embodiments within the scope of the following claims.

I claim:

1. A weatherable, mechanically stable polypropylene/date palm (Phoenix) fiber reinforced composite, comprising:
at least one cellulosic fiber material selected from date palm leaves, stems, and roots, and mixtures thereof present in an amount in the range of from about 20% to about 50% by weight of said composite;
at least one polypropylene material present in an amount in the range from about 50% to about 80% by weight of said composite, said at least one polypropylene material comprising at least one UV stabilizer present in an amount in the range of about 0.1 to about 0.5 parts per 100 parts of polypropylene resin and at least one lubricant present in an amount of about 4 to about 8 parts per 100 parts of polypropylene resin.

2. A polypropylene/date palm fiber composite according to claim 1, wherein said at least one polypropylene material is present in an amount in the range of from about 60% to about 70% by weight of said composite.

3. A polypropylene/date palm fiber composite according to claim 1, wherein said at least one cellulosic fiber material is present in an amount in the range of from about 30% to about 40% by weight of said composite.

4. A polypropylene/date palm fiber composite according to claim 1, further comprising at least one polar modified polypropylene compatibilizer material in an amount in the range of from about 1% to about 6% by weight of said composite.

5. A polypropylene/date palm fiber composite according to claim 4, wherein said at least one polar modified polypropylene material is a maleated polypropylene.

6. A polypropylene/date palm fiber composite according to claim 1, wherein said at least one UV stabilizer is present in an amount in the range of about 0.2 to about 0.4 parts per 100 parts of polypropylene resin.

7. A polypropylene/date palm fiber composite according to claim 7, wherein said UV stabilizer is a metal soap selected from the group comprising metal soaps of tin, barium, cadmium, and zinc.

8. A polypropylene/date palm fiber composite according to claim 1, wherein said at least one lubricant is present in an amount in the range of about 5 parts per 100 parts of polypropylene resin to about 7 parts per 100 parts of polypropylene resin.

9. The polypropylene/date palm fiber composite according to claim 8, wherein said at least one lubricant is selected from the group comprising calcium stearate, paraffin wax, and amide wax.

10. A method of making a polypropylene/date palm (phoenix) fiber composite extruded or molded article comprising:
mixing a polypropylene resin with a UV stabilizer in an amount in the range of about 0.1 to about 0.5 parts per 100 parts of polypropylene resin, a lubricant in an amount in the range of about 4 to about 8 parts per 100 parts of polypropylene material, and a polar modified polypropylene compatibilizer in an amount in the range of about 1 to about 6 parts per 100 parts polypropylene resin;
mixing said date palm fiber with said polypropylene resin mixture in relative amounts between about 50% date palm fiber and 50% polypropylene resin mixture to about 20% date palm fiber to about 80% polypropylene resin mixture; and
extruding or molding the resulting mixture of date palm fiber and polypropylene resin mixture through a die to form a composite article.

11. The method of making a polypropylene/date palm fiber composite article of claim 10, further comprising the step of drying said date palm fiber to a moisture content of between 0.5% and 3% by weight.

12. The method of making a polypropylene/date palm fiber composite article of claim 11, further comprising the step of drying said date palm fiber to a moisture content of less than 2% by weight.

13. The method of making a polypropylene/date palm fiber composite article of claim 11, wherein said polypropylene resin mixing step includes a UV stabilizer in an amount in the range of about 0.2 to about 0.5 parts per 100 parts of polypropylene resin, a lubricant in an amount in the range of about 5 to about 7 parts per 100 parts of polypropylene material, and a polar modified polypropylene compatibilizer in an amount in the range of about 1 to about 6 parts per 100 parts polypropylene resin.

14. The method of making a polypropylene/date palm fiber composite article of claim 11, wherein said polypropylene/date palm fiber composite mixture step is mixed in relative amounts between about 40% date palm fiber and 60% polypropylene resin mixture to about 30% date palm fiber to about 70% polypropylene resin mixture.

15. The method of making a polypropylene/date palm fiber composite article of claim 11, wherein said polypropylene resin mixing step includes a UV stabilizer in an amount in the range of about 0.5 parts per 100 parts of polypropylene resin, a lubricant in an amount in the range of about 5 parts per 100 parts of polypropylene resin, and a polar modified polypropylene compatibilizer in an amount of about 4 parts per 100 parts of polypropylene resin, said polypropylene/date palm fiber composite mixture step being mixed in relative amounts of 40% date palm fiber and 60% polypropylene resin mixture.

16. The method of making a polypropylene/date palm fiber composite article of claim 15, wherein the resulting mixture from mixing said date palm fiber and said polypropylene resin mixture is mixed in a ribbon blender for about 2 minutes and the resulting dry blend is fed into a single screw extruder, the first two stages of the extruder being at a temperature of about 220° C. and the last two stages being at a temperature of about 200° C., a vacuum being applied to a vent located between said first two stages and said last two stages, the die temperature being about 200° C., and the screw temperature being about 200° C.

17. A composite article made according to the method of claim 10.
